(19) United States
(12) Patent Application Publication
(10) Pub. No.: US 2026/0043722 A1
(43) Pub. Date: Feb. 12, 2026

(54) FLUID SAMPLING SYSTEM AND METHOD

(71) Applicant: SWAGELOK COMPANY, Solon, OH (US)

(72) Inventor: Takashi Matsuura, Tokyo (JP)

(21) Appl. No.: 19/099,064

(22) PCT Filed: Aug. 2, 2023
(86) PCT No.: PCT/US2023/071475

§ 371 Date: Jan. 28, 2025

Related U.S. Application Data
(60) Provisional application No. 63/394,359, filed on Aug. 2, 2022.

(51) Int. Cl. G01N 1/44

(52) U.S. Cl. CPC G01N 1/44

(57) ABSTRACT

In a method for analyzing a material component of a liquid sample, pressurized gas and a liquid sample are supplied to a collection chamber, and the pressurized gas and the liquid sample are heated to an extraction temperature. The liquid sample is sparged with the pressurized gas to vaporize the material component from the liquid sample into the pressurized gas to form a sample gas. A mixture of the liquid sample, the pressurized gas, and the sample gas is discharged from the collection chamber. A pressure of the sample gas is reduced to bring the sample gas into an unsaturated state. The reduced pressure sample gas is conveyed to an analyzer. The pressurized gas is separated from the mixture and conveyed to a bleed port, and the liquid sample is conveyed to a drain port.

### CROSS-REFERENCE TO RELATED APPLICATION

This application claims priority to and all benefit of U.S. Provisional Patent Application Ser. No. 63/394,359, filed on Aug. 2, 2022, for FLUID SAMPLING SYSTEM AND METHOD, the entire disclosure of which is incorporated herein by reference.

### TECHNICAL FIELD OF THE DISCLOSURE

The inventions relate to fluid sampling systems, and more particularly to fluid sampling systems for collecting and analyzing chemicals extracted from a liquid.

### BACKGROUND OF THE DISCLOSURE

Analytical fluid sampling systems are used to detect the presence and amount of one or more chemicals, such as volatile organic compounds (VOC's), in a collected sample of a liquid (e.g., water). A conventional system for extracting and analyzing VOC's involves combining a sample of the liquid with a gas (e.g., nitrogen) in a tank, heating the mixture to vaporize the VOC's into the gas component, and transporting the gas, with the vaporized VOC's to an analyzer (e.g., gas chromatograph), while passing the liquid sample to a drain. In such an arrangement, conveyance of the saturated gas vapor to the analyzer can result in condensation of the vaporized liquid and VOC's downstream from the tank, and subsequent drainage of these compounds with the drained liquid, may impede the accuracy of the analyzed sample. While such condensation may be avoided by heating the tubing line to the analyzer, in some applications, such heating arrangements may be impractical or impossible.

### SUMMARY OF THE EXEMPLARY EMBODIMENTS

In accordance with an exemplary aspect of one or more of the inventions presented in this disclosure, a sampling system includes a collection chamber, a gas supply line providing pressurized gas to the collection chamber, and a liquid supply line providing liquid to the collection chamber. A heater is assembled with the collection chamber and is configured to heat the pressurized gas and the liquid to an extraction temperature. The collection chamber and heater are configured to vaporize a portion of the liquid into the pressurized gas at the extraction temperature to form a sample gas. An outlet port extends from the collection chamber to a first outlet passage for delivering the sample gas to an analyzer, and to a second outlet passage for delivering a mixture of the liquid and the pressurized gas to a drain port. A water sealing mechanism is assembled with the second outlet passage and is configured to separate the gas from the mixture in the second outlet passage, and to maintain the mixture at a positive pressure. A pressure reducing mechanism is assembled with the first outlet passage and is configured to reduce a fluid pressure of the sample gas to bring the sample gas into an unsaturated state.

In accordance with another exemplary aspect of one or more of the inventions presented in this disclosure, a method for analyzing a material component of a liquid sample is contemplated. In the exemplary method, pressurized gas and the liquid sample are supplied to a collection chamber. The pressurized gas and the liquid sample are heated to an extraction temperature. The liquid sample is sparged with the pressurized gas to vaporize the material component from the liquid sample into the pressurized gas to form a sample gas. The liquid sample, the pressurized gas, and the sample gas are discharged as a mixture from the collection chamber. A pressure of the sample gas is reduced to bring the sample gas into an unsaturated state. The reduced pressure sample gas is conveyed to an analyzer. The pressurized gas in the mixture is separated from the mixture and conveyed to a bleed port. The liquid sample is separated from the mixture and conveyed to a drain port.

In accordance with another exemplary aspect of one or more of the inventions presented in this disclosure, a chemical extraction module includes a collection chamber, a gas supply line providing pressurized gas to the collection chamber, a heater assembled with the collection chamber, a water sealing mechanism, and a pressure reducing mechanism. The gas supply line includes a pressure reducing regulator, a check valve, and a tee fitting for introducing a liquid into the gas supply line. The heater is configured to heat the pressurized gas and the liquid to an extraction temperature, and the collection chamber and heater are configured to vaporize a portion of the liquid into the pressurized gas at the extraction temperature to form a sample gas. An outlet port extends from the collection chamber to a first outlet passage for delivering the sample gas to an analyzer, and to a second outlet passage for delivering a mixture of the liquid and the pressurized gas to a drain port. The water sealing mechanism is assembled with the second outlet passage and is configured to separate the gas from the mixture in the second outlet passage, and to maintain the mixture at a positive pressure. The pressure reducing mechanism is assembled with the first outlet passage and is configured to reduce a fluid pressure of the sample gas to bring the sample gas to an unsaturated state.

These and other aspects, advantages and embodiments of the inventions are further described below in view of the accompanying drawings.

### BRIEF DESCRIPTION OF THE DRAWINGS

FIG. 1 schematically illustrates a system for extracting and analyzing a chemical from a liquid sample, in accordance with an exemplary embodiment of the present disclosure;

FIG. 2 schematically illustrates a water sealing mechanism for a system for extracting and analyzing a chemical from a liquid sample, in accordance with another exemplary embodiment of the present disclosure;

FIG. 3 illustrates an exemplary chemical extraction module, in accordance with another exemplary embodiment of the present disclosure; and

FIG. 4 illustrates another exemplary chemical extraction module, in accordance with another exemplary embodiment of the present disclosure.

### DESCRIPTION OF EXEMPLARY EMBODIMENTS

This Detailed Description merely describes exemplary embodiments and is not intended to limit the scope of the claims in any way. Indeed, the invention as claimed is broader than and unlimited by the exemplary embodiments, and the terms used in the claims have their full ordinary meaning. For example, while the specific embodiments described herein relate to arrangements for collecting and analyzing a volatile organic compound contained in a liquid, the features of the present disclosure may additionally or alternatively be applied to other types of fluid systems and sampling arrangements.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Parameters identified as “approximate” or “about” a specified value are intended to include the specified value, values within 5% of the specified value, and values within 10% of the specified value, unless expressly stated otherwise. Further, it is to be understood that the drawings accompanying the present disclosure may, but need not, be to scale, and therefore may be understood as teaching various ratios and proportions evident in the drawings. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

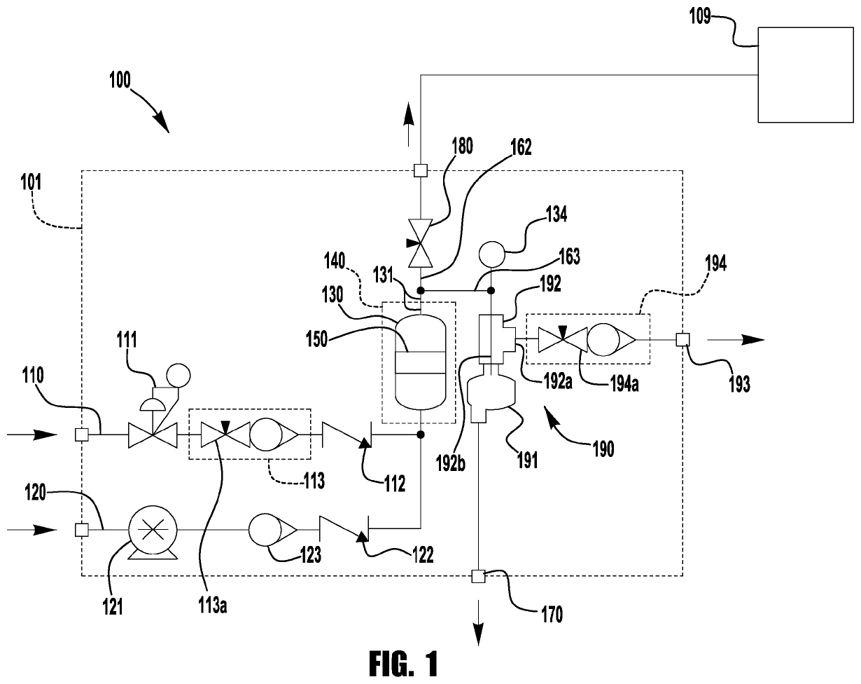

FIG. 1 schematically illustrates a system 100 for extracting and analyzing a dissolved component of a liquid sample, in accordance with an exemplary embodiment of the present disclosure. In the exemplary system 100, a pressurized gas (e.g., air or nitrogen pressurized, for example, to between about 100 kPa and about 500 kPa, or between about 100 kPa and about 200 kPa) and a sample liquid (e.g., water) are supplied from gas and liquid sources G, L to respective supply lines 110, 120 to supply gas and liquid to a collection chamber 130 (e.g., tank or cylinder). Pressure and flow rate of the gas may be controlled by a pressure reducing regulator 111, and pressure and flow rate of the liquid may be controlled by a metering pump 121. As shown, the gas and liquid supply lines 110, 120 may be provided with check valves 112, 122 to prevent backflow, and/or flowmeters 113, 123 (e.g., rotameter devices) to monitor flow rates. The gas supply line flowmeter 113 may be provided with an integrated regulating valve 113a (e.g., needle valve) for gas flow rate adjustment.

The exemplary collection chamber 130 is provided with a heater 140 for maintaining the collected fluids at an elevated temperature (e.g., between about 40° C. and about 80° C., or about 50° C.). The collection chamber 130 and heater 140 function to mix the gas with the liquid, causing a portion of the liquid and its components (e.g., VOC's) to be vaporized from the liquid and absorbed by the collected gas. While the collection chamber 130 and heater 140 may inherently function as a sparger for mixing the gas and liquid, in other embodiments, the collection chamber 130 may be further provided with a sparging arrangement 150 (e.g., a bubbler, filter, impeller, and/or other sparger assembly) to facilitate mixing.

The liquid and gas, with the vaporized components, are expelled from the collection chamber 130 through an outlet port 131. The gas in the outlet port 131 passes through a first outlet passage 162 to an analyzer (e.g., gas chromatograph, not shown) for analysis of the content and composition of the material components extracted from the liquid sample, while the liquid in the outlet port passes or drains, by gravity feed, through a second outlet passage 163 to a drain port 170.

According to an exemplary aspect of the present disclosure, in an exemplary arrangement, the fluid pressure within the collection chamber 130 is maintained at a positive pressure (e.g., between about 100-500 kPa or between about 100-200 kPa), and the vaporized liquid flowing to the first outlet passage 162 passes through a pressure reducing mechanism 180 (e.g., a flow regulating valve, such as a needle valve, or a pressure reducing regulator) to bring the vaporized fluid into an unsaturated state, thereby preventing or minimizing condensation of the vaporized liquid (and its material components). In one such arrangement, the pressure reducing mechanism 180 may provide a reduction in pressure, for example, to about atmospheric pressure. The flow coefficient (Cᵥ) through the pressure reducing mechanism 180 may be user adjustable, for example, to maintain a constant flow rate to the analyzer.

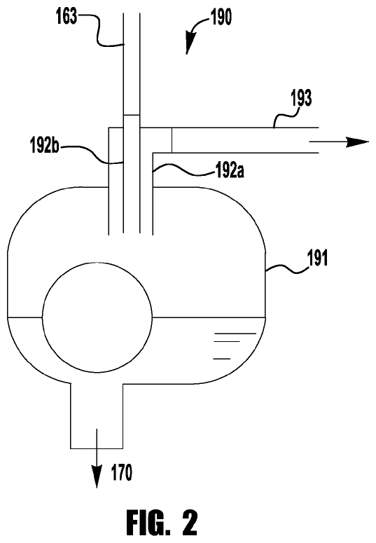

To maintain the positive internal pressure of the collection chamber 130 and to separate the gas from a gas-liquid mixture in the second outlet passage 162, in an exemplary embodiment, a water sealing mechanism 190 is provided in the second outlet passage. While a variety of suitable water sealing mechanisms may be utilized, in an exemplary embodiment, the water sealing mechanism 190 (schematically shown in greater detail in FIG. 2) includes an air trap 191 (e.g., a float-type air trap) installed in the second outlet passage 163 to separate the liquid and gas, and a double-tube bleed line 192 diverting the separated gas through a first passage 192a of the double-tube bleed line 192 to a bleed passage 193 while allowing the liquid to pass through a second passage 192b to the air trap 191.

In an exemplary embodiment, the double-tube bleed line includes a reducing tee fitting, including a reduced connection (e.g., ¼ inch) upward extending run bored-through to receive the second outlet passage 163 (e.g., ¼ inch tube) therethrough to receive a mixture of liquid and gas from the collection chamber, with the second outlet passage 163 extending to the air trap 191. In the air trap 191, the mixture exits the end of the second passage 192b, with the liquid being gravity fed into the bottom of the air trap, and the gas flowing up through the annulus between the ID of the first passage 192a and the OD of the second passage 192b, and through the standard (e.g., ½ inch) branch connector to the bleed passage.

Separation of the gas from the second outlet passage 163 may reduce the possibility of contamination and may enable an improvement in the precision of the analysis. The fluid pressure in the second outlet passage 163 may be monitored, for example, using a pressure gage 134. The separated gas may be monitored and/or controlled, using, for example, a flow meter 194 (e.g., rotameter), which may be provided with an integrated regulating valve 194a (e.g., needle valve) for gas flow rate adjustment.

In some embodiments, a system may include a module providing a prefabricated assembly of components for ease of installation. As one such example, components of the chemical extraction arrangement may be mounted to a panel or enclosure for installation as a chemical extraction module in a fluid sampling system. In the exemplary system 100 of FIG. 1, a module 101 may be provided with components and connections suitable for direct connection with the liquid source, gas source, analyzer, drain, and bleed passage.

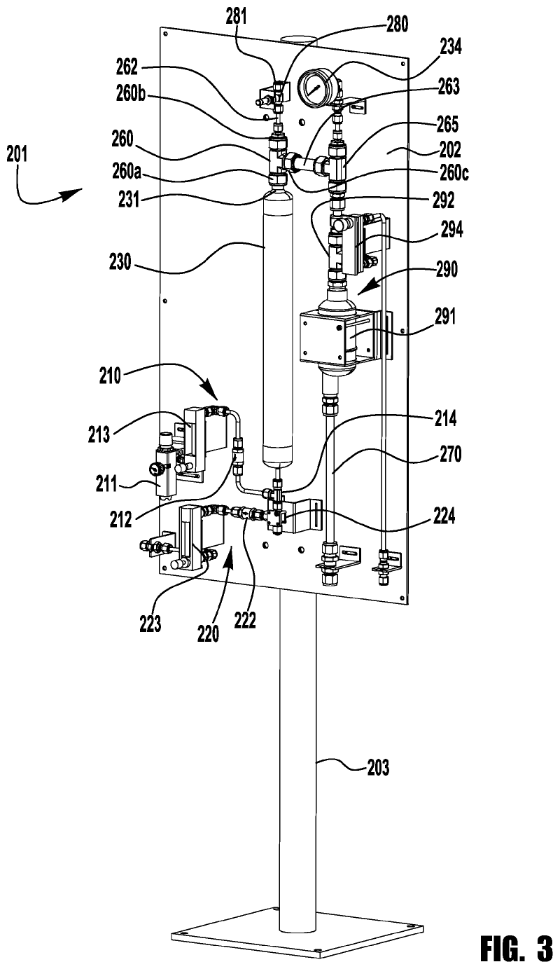

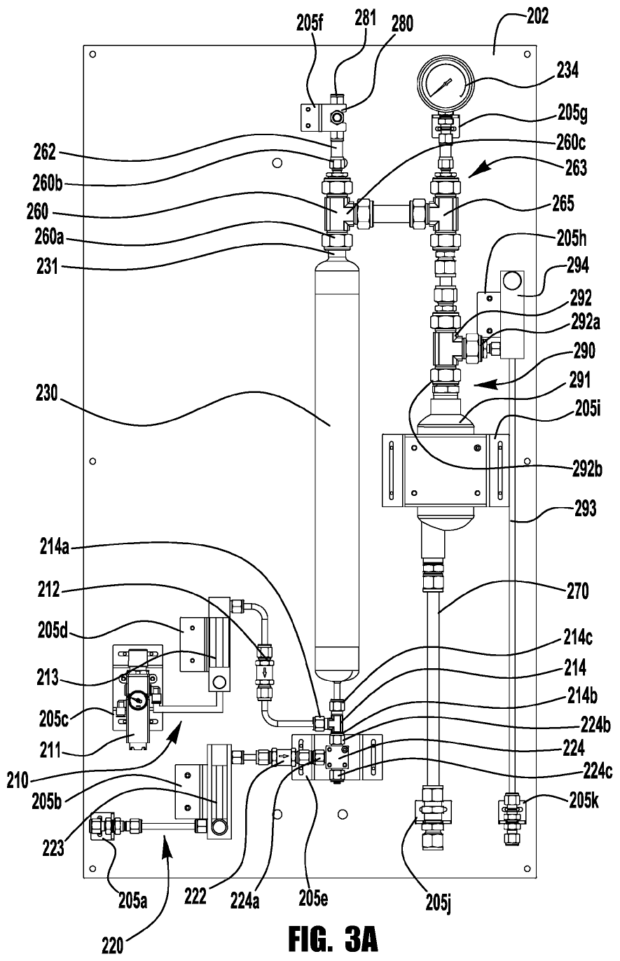

FIGS. 3 and 3A illustrate an exemplary module 201 including a panel or substrate 202 and stand 203 on which the module components are mounted (e.g., by brackets 205a-k, as shown). In the exemplary module 201, gas and liquid supply lines 210, 220 provide connections (e.g., tube fittings) for gas and liquid sources to supply gas and liquid to a collection chamber, such as, for example, a tank or cylinder 230. The gas supply line 210 includes a pressure reducing regulator 211, a flowmeter 213 (e.g., with integrated needle valve, not shown, for gas flow rate adjustment) to monitor flow rate, and a check valve 212 to prevent backflow. The liquid supply line 220 includes a flowmeter 223 to monitor flow rate and a check valve 222 to prevent backflow. The liquid supply line may additionally include a metering pump (not shown) for control of pressure and flow rate of the liquid, similar to the schematically illustrated embodiment of FIG. 1. In some such embodiments, the metering pump may be separate from the module. The gas and liquid supply lines 210, 220 include appropriate fittings 214, 224 (e.g., tee fittings) for combining the gas and liquid for supply to the cylinder 230, and for facilitating purging/drainage of the cylinder and supply lines. In the illustrated example, the gas supply line tee fitting 214 includes a run port 214a connected to the gas supply line 210, a first branch port 214b connected to a first branch port 224b of the liquid supply line tee fitting 224, and a second branch port 214c connected to the cylinder 230. The liquid supply line tee fitting 224 includes a run port 224a connected to the liquid supply line 220 and a capped second branch port 224c, which may be open to facilitate purging or drainage of the cylinder 230 or liquid supply line 220.

The cylinder 230 may be provided with a heater (not shown) for maintaining the collected fluids at an elevated temperature (e.g., between about 40° C. and about 80° C., or about 50° C.). While the cylinder 230 and heater 240 may inherently function as a sparger for mixing the gas and liquid, in other embodiments, the cylinder 230 may be further provided with a sparging arrangement (e.g., a bubbler, filter, impeller, and/or other sparger assembly, not shown) to facilitate mixing.

The liquid and gas, with the vaporized components, are expelled from the cylinder 230 through an outlet port 231. A tee fitting 260 includes an inlet port 260a assembled with the cylinder outlet port 231 and a first outlet port 260b that directs the gas through a first outlet passage 262 to a regulating valve 280 (e.g., needle valve). The regulating valve 280 includes an end connection 281 for connecting to an analyzer supply line supplying the gas to an analyzer (not shown), for analysis of the content and composition of the material components extracted from the liquid sample.

The tee fitting 260 includes a second outlet port 260c that directs the liquid, by gravity feed, through a second outlet passage 263 for drainage (through drain passage 270). The fluid pressure within the cylinder 230 is maintained at a positive pressure (e.g., between about 100-500 kPa or between about 100-200 kPa) by a water sealing mechanism 290 assembled with the second outlet passage 263 and configured to separate the gas from a gas-liquid mixture discharged from the cylinder 230. The water sealing mechanism 290 includes an air trap 291 (e.g., a float-type air trap) installed in the second outlet passage 263 to separate the liquid and gas, and a double-tube bleed line 292 (e.g., the double-tube bleed line arrangement of FIG. 2) diverting the separated gas through a first passage of the double-tube bleed line 292 to a bleed passage 293 while allowing the liquid to pass through a second passage to the air trap 291.

In an exemplary embodiment, the double-tube bleed line includes a reducing tee fitting, including a reduced connection (e.g., ¼ inch) upward extending run bored-through to receive the second outlet passage (e.g., ¼ inch tube) therethrough to receive a mixture of liquid and gas from the collection chamber, with the second outlet passage extending to the air trap (as shown in FIG. 2). In such an arrangement, the mixture exits the end of the second passage, with the liquid being gravity fed into the bottom of the air trap, and the gas flowing up through the annulus between the ID of the first passage and the OD of the second passage, and through the standard (e.g., ½ inch) branch connector to the bleed passage.

Separation of the gas from the second outlet passage 263 may reduce the possibility of contamination and may enable an improvement in the precision of the analysis. The fluid pressure in the second outlet passage 263 may be monitored, for example, using a pressure gage 234 connected with the second outlet passage (e.g., using a tee fitting 265). The separated gas may be monitored and/or controlled, using, for example, a rotameter or other such flow monitor 294, which may include an integrated regulating valve (e.g., needle valve), not shown, for gas flow rate adjustment.

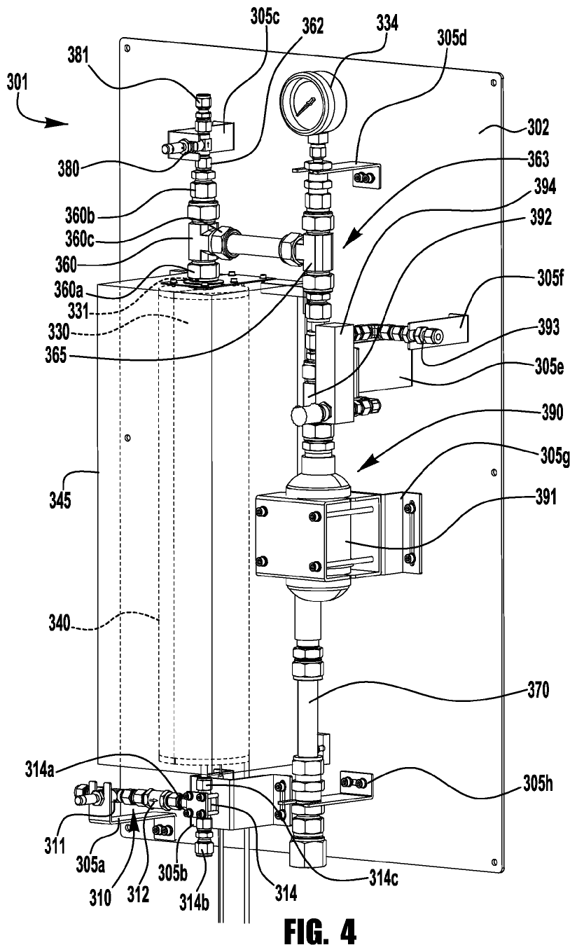

FIG. 4 illustrates another exemplary module 301 including a panel or substrate 302 on which the module components are mounted (e.g., by brackets 305a-h, as shown). In the exemplary module 301, a gas supply lines 310 provides a connection (e.g., tube fittings) for a gas source to supply gas to a tank or cylinder 330. The gas supply line 310 includes a pressure reducing regulator 311 (e.g., regulating valve) and a check valve 312 to prevent backflow. The gas supply line 310 includes an appropriate fitting 314 (e.g., tee fitting) for introducing a liquid into the gas supply line and combining the gas and liquid for supply to the cylinder 330. In the illustrated example, the gas supply line tee fitting 314 includes a run port 314a connected to the gas supply line 310, a first branch port 314b for connection with a liquid supply line (not shown), and a second branch port 314c connected to the cylinder 330.

The tank/cylinder 330 may be provided with a heater 340 for maintaining the collected fluids at an elevated temperature (e.g., between about 40° C. and about 80° C., or about 50° C.), and a sparging arrangement (e.g., a bubbler or other sparger assembly, not shown) for mixing the gas with the liquid, causing a portion of the liquid and its components (e.g., VOC's) to be vaporized from the liquid and absorbed by the collected gas. A heater housing 345 may be mounted to the module substrate to enclose the cylinder 330 and heater 340, for example, for insulation and/or user protection from hot surfaces. The liquid and gas, with the vaporized components, are expelled from the cylinder 330 through an outlet port 331. A tee fitting 360 includes an inlet port 360a assembled with the cylinder outlet port 331 and a first outlet port 360b connected with a first outlet passage 362 to direct the sample gas to a regulating valve 380 (e.g., needle valve). The regulating valve 380 includes an end connection 381 for connecting to an analyzer supply line supplying the gas to an analyzer (not shown), for analysis of the content and composition of the material components extracted from the liquid sample.

The tee fitting 360 directs the liquid, by gravity feed, through a second outlet port 360c connected with a second outlet passage 363 for drainage. The fluid pressure within the cylinder 330 is maintained at a positive pressure (e.g., between about 100-500 kPa or between about 100-200 kPa) by a water sealing mechanism assembled with the second outlet passage 363 and configured to separate the gas from a gas-liquid mixture discharged from the cylinder 330. The water sealing mechanism 390 includes an air trap 391 (e.g., a float-type air trap) installed in the second outlet passage 363 to separate the liquid and gas, and a double-tube bleed line 392 (e.g., the double-tube bleed line arrangement of FIG. 2) diverting the separated gas through a first passage of the double-tube bleed line 392 to a bleed passage 393 while allowing the liquid to pass through a second passage to the air trap 391.

In an exemplary embodiment, the double-tube bleed line includes a reducing tee fitting, including a reduced connection (e.g., ¼ inch) upward extending run bored-through to receive the second outlet passage 363 (e.g., ¼ inch tube) therethrough to receive a mixture of liquid and gas from the collection chamber, with the second outlet passage 363 extending to the air trap 391. In the air trap 391, the mixture exits the end of the second passage, with the liquid being gravity fed into the bottom of the air trap, and the gas flowing up through the annulus between the ID of the first passage and the OD of the second passage, and through the standard (e.g., ½ inch) branch connector to the bleed passage 393.

Separation of the gas from the second outlet passage 363 may reduce the possibility of contamination and may enable an improvement in the precision of the analysis. The fluid pressure in the second outlet passage 363 may be monitored, for example, using a pressure gage 334 connected with the second outlet passage (e.g., using a tee fitting 365). The separated gas may be monitored and/or controlled, using, for example, a rotameter or other such flow meter 394.

The inventive aspects have been described with reference to the exemplary embodiments. Modification and alterations will occur to others upon a reading and understanding of this specification. It is intended to include all such modifications and alterations insofar as they come within the scope of the appended claims or the equivalents thereof.

1. A sampling system comprising:
a collection chamber;
a gas supply line providing pressurized gas to the collection chamber;
a liquid supply line providing liquid to the collection chamber;
a heater assembled with the collection chamber and configured to heat the pressurized gas and the liquid to an extraction temperature, the collection chamber and heater being configured to vaporize a portion of the liquid into the pressurized gas at the extraction temperature to form a sample gas;
an outlet port extending from the collection chamber to a first outlet passage for delivering the sample gas to an analyzer, and to a second outlet passage for delivering a mixture of the liquid and gas to a drain port;
a water sealing mechanism assembled with the second outlet passage and configured to separate the gas from the mixture in the second outlet passage, and to maintain the mixture at a positive pressure; and
a pressure reducing mechanism assembled with the first outlet passage and configured to reduce a fluid pressure of the sample gas to bring the sample gas to an unsaturated state.

2. The system of claim 1, wherein the pressure reducing mechanism comprises a regulating valve.

3. The system of claim 1, wherein the pressure reducing mechanism comprises a needle valve.

4. The system of claim 1, wherein the water sealing mechanism comprises an air trap.

5. The system of claim 4, wherein the air trap is a float-type air trap.

6. The system of claim 4, wherein the water sealing mechanism includes a double-tube bleed line defining a first passage for diverting separated gas to a bleed passage, and a second passage for directing liquid to the air trap.

7. The system of claim 6, wherein the double-tube bleed line comprises a tee fitting having a bore receiving therethrough a conduit defining the second passage, with the first passage being defined by an annulus between an inner diameter of the tee fitting bore and an outer diameter of the conduit.

8. A method for analyzing a material component of a liquid sample, the method comprising:
supplying pressurized gas to a collection chamber;
supplying the liquid sample to the collection chamber;
heating the pressurized gas and the liquid sample to an extraction temperature;
sparging the liquid sample with the pressurized gas to vaporize the material component from the liquid sample into the pressurized gas to form a sample gas;
discharging a mixture of the liquid sample, the pressurized gas, and the sample gas from the collection chamber;
reducing a pressure of the sample gas to bring the sample gas into an unsaturated state;
conveying the reduced pressure sample gas to an analyzer;
separating the pressurized gas from the mixture and conveying the pressurized gas to a bleed port; and
conveying the liquid sample to a drain port.

9. The method of claim 8, wherein reducing the pressure of the sample gas comprises conveying the sample gas through a regulating valve.

10. The method of claim 8, wherein reducing the pressure of the sample gas comprises conveying the sample gas through a needle valve.

11. The method of claim 8, wherein reducing the pressure of the sample gas comprises reducing the pressure of the sample gas from a first pressure between about 100 kPa and about 200 kPa to a second pressure of about atmospheric pressure.

12. The method of claim 8, wherein the extraction temperature is between about 40° C. and about 80° C.

13. The method of claim 8, wherein separating the pressurized gas from the mixture comprises conveying the mixture through an air trap.

14. The method of claim 8, wherein separating the pressurized gas from the mixture comprises conveying the mixture through a float-type air trap.

15. The method of claim 8, wherein conveying the pressurized gas to the bleed port comprises conveying the gas through a first passage of a double-tube bleed line, and conveying the liquid to the drain port comprises conveying the liquid through a second passage of the double-tube bleed line.

16. The method of claim 15, wherein the double-tube bleed line comprises a tee fitting having a bore receiving therethrough a conduit defining the second passage, with the first passage being defined by an annulus between an inner diameter of the tee fitting bore and an outer diameter of the conduit.

17. A chemical extraction module comprising:
a collection chamber;
a gas supply line providing pressurized gas to the collection chamber, the gas supply line comprising a pressure reducing regulator, a check valve, and a tee fitting for introducing a liquid into the gas supply line;
a heater assembled with the collection chamber and configured to heat the pressurized gas and the liquid to an extraction temperature, the collection chamber and heater being configured to vaporize a portion of the liquid into the pressurized gas at the extraction temperature to form a sample gas;
an outlet port extending from the collection chamber to a first outlet passage for delivering the sample gas to an analyzer, and to a second outlet passage for delivering a mixture of the liquid and the pressurized gas to a drain port;
a water sealing mechanism assembled with the second outlet passage and configured to separate the pressurized gas from the mixture in the second outlet passage, and to maintain the mixture at a positive pressure; and
a pressure reducing mechanism assembled with the first outlet passage and configured to reduce a fluid pressure of the sample gas to bring the sample gas to an unsaturated state.

18. The chemical extraction module of claim 17, further comprising a liquid supply line connected to the tee fitting for providing the liquid to the gas supply line.

19. The chemical extraction module of claim 17, wherein the water sealing mechanism includes an air trap and a double-tube bleed line defining a first passage for diverting separated gas to a bleed passage, and a second passage for directing the liquid to the air trap.

20. The chemical extraction module of claim 19, wherein the double-tube bleed line comprises a tee fitting having a bore receiving therethrough a conduit defining the second passage, with the first passage being defined by an annulus between an inner diameter of the tee fitting bore and an outer diameter of the conduit.
